(19) United States
(12) Patent Application Publication
(10) Pub. No.: US 2009/0088057 A1
(43) Pub. Date: Apr. 2, 2009

(54) Sharpening system having multiple abrasive components

(76) Inventor: Richard S. Smith, Hot Springs, AR (US)

Correspondence Address: EDWARD D. GILHOOLY, 28 E. JACKSON BLVD., SUITE 423, CHICAGO, IL, 60604, US

(21) Appl. No.: 11/982,469

(22) Filed: Oct. 31, 2007

Related U.S. Application Data
(63) Continuation of application No. 11/286,423, filed on Nov. 25, 2005, now abandoned.

(51) Int. Cl. B23F 21/03

(52) U.S. Cl. 451/552

(57) ABSTRACT

An abrasive sharpening system having multiple sharpening stations supported on a base. One of the stations includes ceramic rods having a partial curved outer surface and a pair of flat intersecting surfaces forming a longitudinally extending abrasive edge. The base further supports a flat abrasive stone and a pair of carbide blades for sharpening.

### BACKGROUND OF THE INVENTION

1. Field of the Invention

This invention relates in general to abrasive sharpeners and, more particularly, to a sharpening system having multiple abrasive stations.

2. Summary of the Prior Art

Numerous abrasive sharpeners have been developed in the past for sharpening knives, scissors, tools, fishing hooks, and the like. Known abrasive surfaces may be provided by abrasive rods, abrasive stones, and carbide abrasive elements. Prior art abrasive rods typically are formed as separate cylindrical rods and triangular rods, often supported on a base. Such separate triangular and cylindrical rods are disclosed in U.S. Pat. No. 4,231,194 issued Nov. 4, 1980 to Glesser and U.S. Pat. No. 5,477,753 issued Dec. 26, 1995 to Branscum et al. A slot is also provided in the triangular rod disclosed in the foregoing Glesser U.S. Pat. No. 4,231,194 for providing the added capability of sharpening fish hooks. In certain situations a cylindrical rod such as shown in the foregoing Branscum et al. patent ('753) is a more effective sharpening element for straight edged knives than a triangular rod, while the shaped edge of a triangular rod is preferred in many cases for sharpening serrated edges. A flat surface can also be advantageous in sharpening other flat edged knives.

In the past, separate rods have been needed when a particular knife was best sharpened by a flat abrasive surface, a round abrasive surface or an abrasive edge In addition, prior systems have not effectively combined the benefits of abrasive rods with other abrasive components in a multi-use system to perform a wide range of sharpening techniques in a single economical design. Accordingly, it is desirable in the prior art to provide an improved sharpening system having multiple abrasive components for use with a wide range of implements, including, but not limited to, tools, instruments, scissors, fish hooks, and the like.

### SUMMARY OF THE INVENTION

It is therefore an objective of the invention to provide an improved sharpening system having multiple abrasive components or stations. The sharpening system herein disclosed includes a plurality of ceramic rod means having a novel configuration by which a portion of the longitudinally extending surface possesses a curved, partially cylindrical shape and the other portion includes a pair of flat, partial triangular surfaces longitudinally extending on the opposite side. The triangular portion provides a sharp edge and flat surfaces opposite to the round surface on a single unitary rod. The novel rod means herein can provide effective sharpening results for serrated or flat knives and the like dependent on which type of surface is desired. Such a multiple surface rod is convenient to use, provides highly efficient sharpening and is relatively more economical than using separate elements to attain the desired sharpening effects. The advantages of the foregoing configuration of the invention are further enhanced with an elongated groove for sharpening fish hooks or other implements. Although not intended to be so limited, the rods provide a fine abrasive surface.

The system herein disclosed is further equipped with an improved abrasive stone having an interrupted diamond surface formed from an overlapping hole design. This design speeds sharpening by collecting and holding the metal filings that ordinarily build up during the sharpening process, thus allowing the surface to remain clear and clean. The abrasive stone may also provide a fine grinding surface.

The abrasive rods and the abrasive stone are protected during non-use by being stored within the base of the system of the invention. The abrasive stone is covered by a removable cover that also serves as a hand guard during use of the abrasive rods for sharpening. A third abrasive sharpener is provided by replaceable and reversible carbide blades that facilitate a course cutting head. The carbide blades provide specifically designed “V” shaped cutting slots that are aligned to deliver the optimum sharpening angle. The invention herein disclosed thus is directed to a 3-in-1 sharpening system capable of optimum results for knives, tools, instruments, fish hooks, and other articles which require sharpening.

### BRIEF DESCRIPTION OF THE DRAWINGS

FIG. 1 is a front perspective view of the abrasive sharpening system of the invention without the stone cover/guard and showing two abrasive rods in upright work position;

FIG. 2 is a top plan of the base of the abrasive sharpening system of FIG. 1 with the abrasive stone cover/guard removed:

FIG. 3 is a side elevational view of the base of the abrasive sharpening system of FIG. 1 with the stone cover/guard removed;

FIG. 4 is a bottom plan view of the base of the abrasive sharpening system of FIG. 1;

FIG. 5 is a sectional end view taken along lines 5-5 of FIG. 4 showing a pair of abrasive rods being stored in a rod storage compartment;

FIG. 6 is a side elevational view of one of the abrasive rods of the sharpening system of FIG. 1;

FIG. 7 is an end elevational view of the abrasive rod of FIG. 5;

FIG. 8 is a side elevational view showing use of the abrasive rods;

FIG. 9 is side elevational view showing use of the pair of carbide abrasive elements;

FIG. 10 is a side elevational view of the pair of carbide abrasive elements;

FIG. 11 is a partial top perspective view of the abrasive stone of FIG. 1, FIG. 12 is a partial side elevational view of the abrasive sharpening system of FIG. 1 having the cover/guard shown in a raised position to serve as a guard:

FIG. 13 is a left end elevational view of FIG. 2 showing the abrasive sharpening system of the invention: and

FIG. 14 is a right end elevational view of FIG. 2 showing the abrasive sharpening system of the invention.

### DESCRIPTION OF THE PREFERRED EMBODIMENT

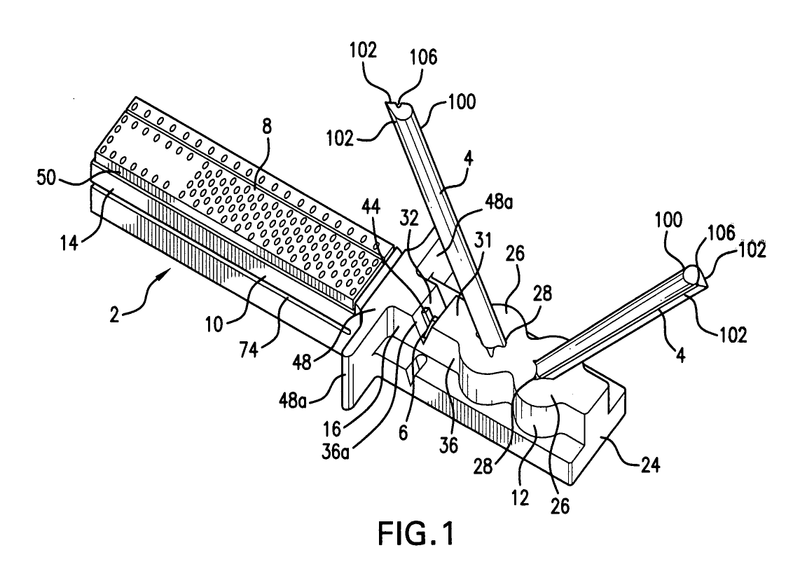

Referring now to FIGS. 1 there is illustrated the abrasive sharpening system of the invention, generally designated by reference numeral 2. In FIG. 1 sharpening system 2 includes three sharpening stations formed by a pair of angularly oriented upright rods 4, a carbide sharpener station 6, and a flat abrasive stone 8, all of which will be described in detail later. Each of the rods 4, carbide sharpening station 6, and flat stone 8 are supported on a base 10 which is formed of a durable plastic material and the like.

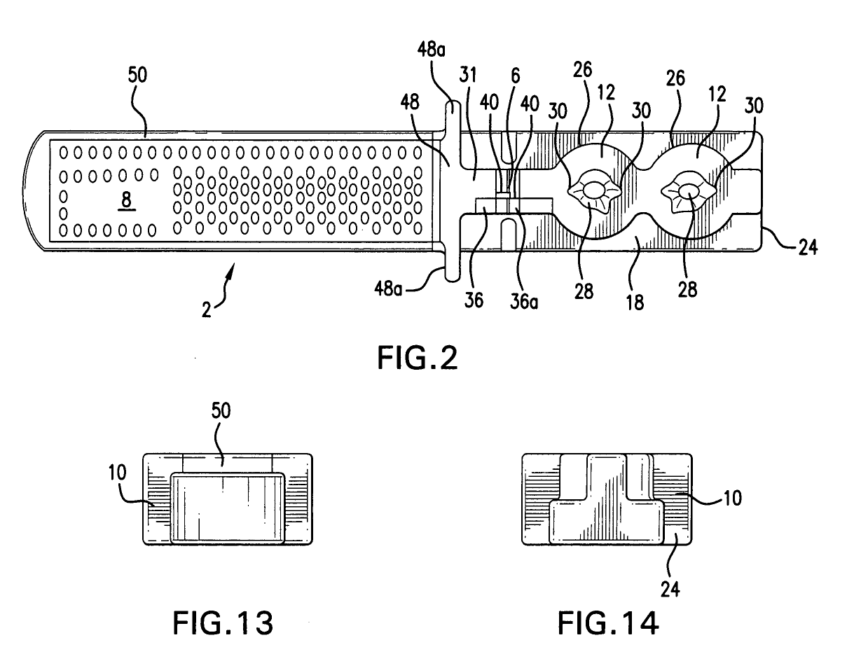

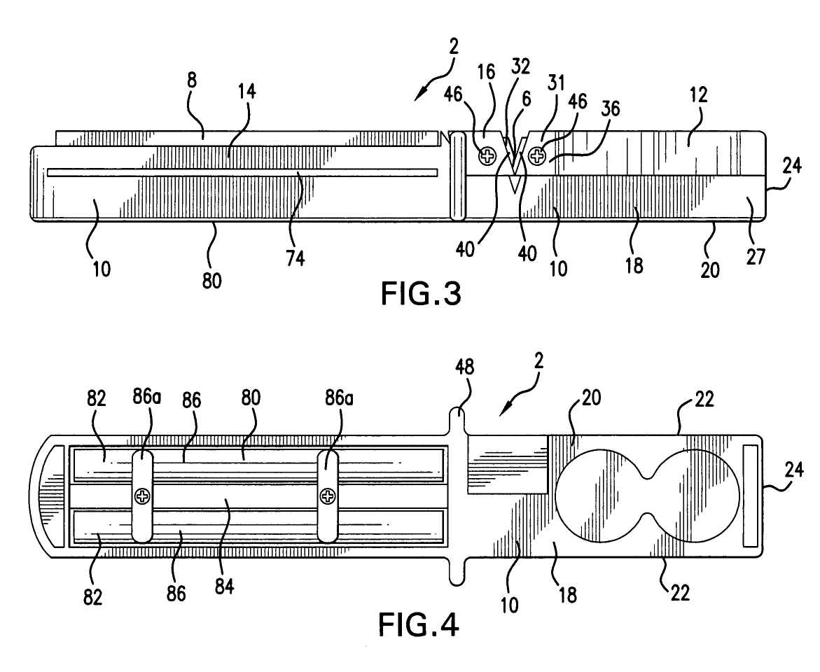

Referring to FIGS. 1-3 and 13, base 10 possesses an upper rod support portion 12 for supporting abrasive rods 4 and an opposite upper portion 14 FIGS. 1 and 3) for supporting and storing flat abrasive stone 8. The carbide sharpener 6 is positioned in a narrowed upper portion 16 of base 10 intermediate of upper portions 12 and 14. Both support portion 12 and upper portion 16 are carried on the top of a lower base section 18 having a rectangular configuration with a flat bottom wall 20, a pair of flat vertical side walls 22 and an end wall 24. The support portion 12 includes a pair of interconnected upper protrusions 26 having a pair of upper holes 28 to form recessed areas for the abrasive rods 4 as seen in FIGS. 1-3. The holes 28 respectively angularly extend into protrusions 26 and partially into base 18 for supporting an end portion of abrasive rod 4 angularly in an upright configuration for sharpening. The holes 28 both are formed with V-shaped cut-out areas 30 to better support an inserted rod 4 during use as seen in FIG. 2.

The upper portion 31 of carbide station 6 includes a V-shaped slot 32 accessible from the top of upper portion 31 as seen in FIGS. 1 and 3. As further seen in FIGS. 1-3, a section 34 of upper portion 31 is cut-out for receiving a clamp member 36. A V-shaped slot 36a is formed in clamp member 36 in alignment with slot 32 to create a vertical slot for receiving ceramic blades 40, such as shown in FIGS. 1, 3, 9, and 10. The internal edges 36b of clamp member 36 are offset from each other to mount the carbide blades 40 in side by side relationship when viewed from a plan view. As illustrated in FIG. 10, the carbide blades 40 are made from tungsten into flat members having an upper beveled edge 42 that forms a V-shaped sharpening area 44 between the blades. The clamping member 36 is removeably secured to the upper portion 31 by screw 46 (FIG. 3) to clamp the carbide blades 40 in place against upper portion 31 for sharpening. The clamp member 36 may be removed to permit replacement or reversal of the orientation of the carbide blades 40.

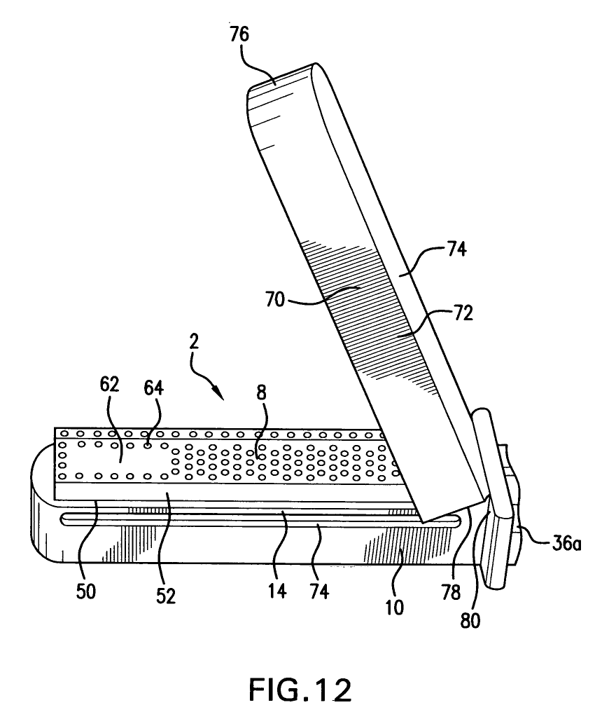

An upright guard 48 is integrally formed on the base 10 between the carbide sharpener 6 and flat stone 8. The vertically end portions 48a of guard 48 extend beyond the sides of the base 8 for protection to the user during sharpening. A stone receiving compartment 50 having a rectangular cross-section is formed on the upper surface of base 10 for receiving a lower portion of the abrasive stone 8 for storage and for sharpening operation. The base 52 of abrasive stone 8 is formed of a plastic and includes a flat bottom surface 54 (FIG. 11) and a pair of flat end walls 56 and side walls 58. A flat nickel plate 60 is bonded to the upper surface of stone base 52 and multiple layers of micron sized monocrystalline diamonds are bonded to the upper surface 62 of plate 60. The plate 60 is provided with a plurality of overlapping holes 64 in which the material of the base extends. The presence of holes 64 having a plastic material adjacent to the abrasive surface 62 speeds up sharpening by collecting and holding the metal filings that ordinarily build up during the sharpening process.

As seen in FIG. 12, a protective cover 70 is removeably attached to the base 10 to protect the abrasive stone 8 during non-use. The cover 70 has a modified U-shaped cross-section defining a pair of spaced flat side walls 72 and an integral top wall 74 and end wall 76. The configuration of the cross-section of cover 70 is correspondently shaped to slide over the end of the base 10 to cover the stone 8 during storage. The cover 70 includes opposed ribs (not shown) extending longitudinally along the internal surface of side wall 72 to be slideably retained in opposed slots 74 present on opposite sides of base 10 (FIG. 1). The opposite end 78 of cover 70 is open and includes an upper projecting end 80. A horizontal lateral slot 82 is formed on base 10 adjacent to guard 48 to receive the projecting end 80 to retain the cover 70 and convert it into a protective guard in the position shown in FIG. 1.

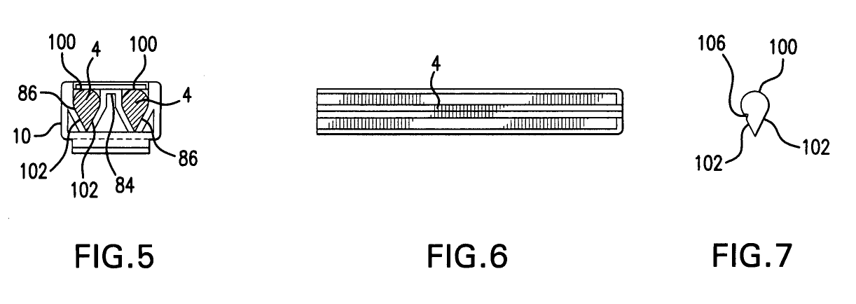

The lower bottom 80 of base 10 beneath abrasive stone includes a lower open storage component 82 for the pair of ceramic rods 4 (FIG. 4). The compartment 82 is divided longitudinally by an intermediate wall 84 to provide a pair of storage areas 86 for a respective ceramic rod. The rods 4 are secured by a pair of wing securement elements 86a that are rotatable between a securement position (FIGS. 4 and 5) to an open position in general alignment with the longitudinal axis of intermediate wall 84 to facilitate release of the rods 4 for use.

Referring to FIGS. 1 and 5-7, the rods 4 are fabricated from a known ceramic abrasive material. The rods 4 have novel cross-sectional shapes as best shown in FIGS. 5 and 7. A portion 100 of the cross-section rod 4 forms a circular outer abrasive surface for approximate 180° to form a semi-cylindrical shape on one side of the rod. Two flat surfaces 102 are provided on the opposite side of portion terminating in a longitudinally extending edge 104 created by intersection of the flat surfaces 102. It should be apparent that the rod 4 is formed as a combined half-cylinder and a triangular cross-section integral with the half cylinder. A longitudinal V-shaped slot 106 extends along one flat surface to sharpen fish hooks (not shown). The flat surfaces 102 are disposed at an angle of 45° to each other.

In use of the sharpener system 2, either end of the base 10 can be manually grasped for support while the other hand of the user uses the sharpening stations on the opposite side of guard 48. The flat abrasive stone 8 may be used to sharpen straight edge blades or other tools and instruments by holding it against the abrasive surface at a selected angle and pushing the blade away from the user for a selected number of strokes while the base 10 is being held against movement at the other end of the base on a support surface. The opposite edge of the blade can be sharpened by pulling it in the opposite direction for a desired number of strokes.

In use of the carbide blade section 6 as seen in FIG. 9, the base 10 is placed on a flat surface and firmly held by the user at a position over the stone 8. With the knife in the other hand, it is pulled between the cutting heads 40 in the slot from the heel of the knife to the point. The carbide blades are pre-aligned to deliver an optimum sharpening angle.

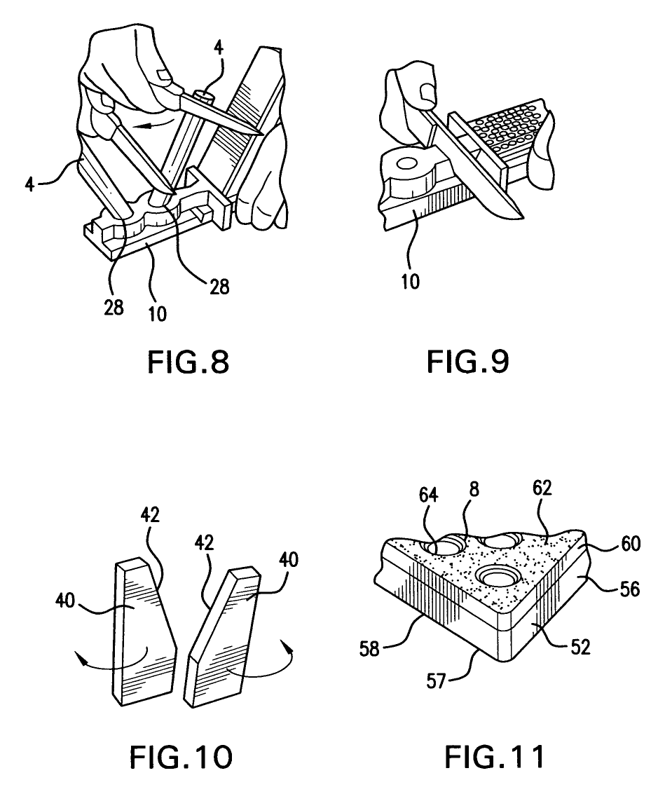

The ceramic rods 4 are removed from the storage areas and inserted into the holes with the same sharpening angle facing each other (FIG. 1 and 8). The cover 70 is placed into the position shown in FIG. 1. While grasping the area of the base 2 over the stone 8, the blade (not shown) of a straight edge knife is pulled on the rod 4 on the right side of FIG. 4 on either the round surface 100 or flat surface 20 down and across for desired number of strokes. The process is then repeated on the inside of the other ceramic rod 4 to sharpen the other side of the knife.

The triangular edge is best used for serrated edges with the triangular edge sliding in and out of the serrations, even extremely small ones. The knife is placed on the inside of the rod 4 with serrations thereof facing the triangular edge. Holding the blade at about a 90° angle to the base 10, the knife is pulled down and across the ceramic rod starting from the back of the knife blade to the lip of the blade. This procedure is repeated for a desired number of strokes to provide optimum sharpening. The foregoing procedure is then repeated on the opposite rod 4 to sharpen the backside of the knife.

1. An abrasive sharpener system comprising
a base,
at least one multi-use abrasive rod having a longitudinal axis, said abrasive rod being selectively supported on said base with said longitudinal axis extending in a generally vertical orientation, and
said rod having a cross-sectional configuration with a partial longitudinally extending curved wall to form curved exterior abrasive surface extending for generally 180°, said curved wall being integral with a pair of intersecting flat walls to form a longitudinally extending edge and a pair of flat abrasive surfaces along said longitudinal axis generally extending 45° to each other.

2. The system according to claim 1 wherein said abrasive rod is a ceramic rod.

3. (canceled)

4. (canceled)

5. The system according to claim 1 wherein said base includes a hole for supporting said abrasive rod angularly upright for a sharpening operation, said base having a plurality of generally V-shaped areas adjacent said hole for better support of said at least one abrasive rod.

6. The system according to claim 5 wherein said at least one abrasive rod includes a pair of abrasive rods, said hole including a pair of holes for supporting a lower end portion of said abrasive rods for a sharpening operation.

7. The system according to claim 6 wherein said base has a compartment for storing said rods.

8. The system according to claim 1 further including a flat abrasive stone mounted on said base means.

9. The abrasive stone according to claim 8 wherein said flat stone means has an interrupted upper abrasive surface.

10. The system according to claim 9 wherein said interrupted surface is formed by a plurality of holes through said upper abrasive surface.

11. The system according to claim 8 wherein said base means includes a V-shaped slot, a pair of opposed carbide cutting blades being supported in said slot forming a V-shaped abrasive surface.

12. An abrasive sharpener system comprising
base,
a plurality of abrasive rods being selectively supported in an angularly upright position to form a first sharpening position,
said plurality of abrasive rods having a cross-sectional configuration with a partial longitudinally extending curved wall to form curved exterior abrasive surface extending for generally 180°, said curved wall being integral with a pair of intersecting flat walls to form a longitudinally extending edge and a pair of flat abrasive surfaces along said longitudinal axis generally extending 45° to each other.
a flat abrasive stone being supported on said to form a second sharpening position,
a pair of flat abrasive blades being further supported in a V-shaped slot formed on said base means to form a third sharpening station having V-shaped sharpening areas formed by beveled edges of said pair of flat abrasive blades, said pair of flat abrasive blades being mounted in an offset relationship to each other in a side by side relationship, said pair of flat abrasive blades further being reversible to reverse orientation to each other,
said base supporting a removable clamp member adjacent said pair of flat abrasive blades to permit removal of said blades for replacement and to further permit said pair of flat abrasive blades to be positioned in said reversed orientation and to be replaced,
said clamp member being removably mounted on said base to secure said pair of flat abrasive blades, and
said clamp member further having a V-shaped slot in alignment with said slot of said base.

13. (canceled)

14. The abrasive sharpener system according to claim 12 wherein one of said flat abrasive surfaces includes a longitudinally extending slot.

15. (canceled)

16. (canceled)

17. The abrasive sharpener system of claim 12 wherein
said at least one abrasive rod area plurality of ceramic rods respectively mounted in holes provided on a top surface of said base, said plurality of holes having V-shaped cut-out areas during sharpening to receive a portion of a respective one of said plurality of ceramic rods.

18. An abrasive rod for a sharpener system comprising
a multi-use abrasive rod having a longitudinal axis said abrasive rod being selectively supported on said base with said longitudinal axis extending in a generally vertical orientation, and
said rod having a cross-sectional configuration with a partial longitudinally extending curved wall to form curved exterior abrasive surface extending for generally 180°, said curved wall being integral with a pair of intersecting flat walls to form a longitudinally extending edge and a pair of flat abrasive surfaces along said longitudinal axis generally extending 45° to each other.
